(19) United States
(12) Patent Application Publication
(10) Pub. No.: US 2026/0333495 A1
(43) Pub. Date: Oct. 22, 2026

(54) METHOD AND APPARATUS FOR MISMATCH OF REQUESTED AND SUPPORTED STEERING FUNCTIONALITIES

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/349,758

(22) Filed: Oct. 3, 2025

(51) Int. Cl. H04W 76/19

(52) U.S. Cl. CPC H04W 76/19

(57) ABSTRACT

Various aspects of the present disclosure relate to mismatch of requested and supported steering functionalities. An apparatus, such as a NE, receives a first request for establishment of a muti-access (MA) packet data network (PDN) connectivity service, where the first request includes a protocol configuration options (PCO) information element (IE) or an extended PCO (ePCO) IE, each including access traffic steering, switching, and splitting (ATSSS) steering functionalities and steering modes. The apparatus transmits a first response that indicates a rejection for the establishment of the MA PDN connectivity service based at least in part on the ATSSS steering functionalities and steering modes being semantically incorrect.

### TECHNICAL FIELD

The present disclosure relates to wireless communications, and more specifically to steering functionalities and steering modes.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to transmit a first request for establishment of a multi-access (MA) packet data network (PDN) connectivity service, where the first request includes a protocol configuration options (PCO) information element (IE) or an extended PCO (ePCO) IE, each including access traffic steering, switching, and splitting (ATSSS) steering functionalities and steering modes, where the ePCO IE includes one or more ATSSS request PCO parameter container contents. The UE may further be configured to, capable of, or operable to receive a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a first request for establishment of a MA PDN connectivity service, where the first request includes a PCO IE or an ePCO IE, each including ATSSS steering functionalities and steering modes, where the ePCO IE includes one or more ATSSS request PCO parameter container contents. The processor may be configured to, capable of, or operable to receive a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect.

A method performed or performable by a UE for wireless communication is described. The method may include transmitting a first request for establishment of a MA PDN connectivity service, where the first request includes a PCO IE or ePCO IE, each including ATSSS steering functionalities and steering modes, where the ePCO IE includes one or more ATSSS request PCO parameter container contents. The method may further include receiving a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect.

An NE (e.g., a core network entity, such as a packet gateway control plane and a session management function (PGW-C+SMF) or other core network entity) for wireless communication is described. The NE may be configured to, capable of, or operable to perform one or more operations as described herein. For example, the NE may be configured to, capable of, or operable to receive a first request for establishment of a MA PDN connectivity service, where the first request includes a PCO IE or an ePCO IE, each including ATSSS steering functionalities and steering modes. The NE may be further configured to, capable of, or operable to transmit a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect.

A processor (e.g., a standalone processor chipset, or a component of a NE) for wireless communication is described. The processor may be configured to, capable of, or operable to perform one or more operations as described herein. For example, the processor may be configured to, capable of, or operable to receive a first request for establishment of a MA PDN connectivity service, where the first request includes a PCO IE or an ePCO IE, each including ATSSS steering functionalities and steering modes. The processor may be configured to, capable of, or operable to transmit a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect.

A method performed or performable by an NE (e.g., a core network entity, such as a PGW-C+SMF or other core network entity) for wireless communication is described. The method may include receiving a first request for establishment of a MA PDN connectivity service, where the first request includes a PCO IE or an ePCO IE, each including ATSSS steering functionalities and steering modes. The method may further include transmitting a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect.

An NE (e.g., a core network entity, such as a mobility management entity (MME), an evolved packet data gateway (ePDG), or other core network entity) for wireless communication is described. The NE may be configured to, capable of, or operable to perform one or more operations as described herein. For example, the NE may be configured to, capable of, or operable to receive a first response that indicates a rejection for an establishment of a MA PDN connectivity service based at least in part on ATSSS steering functionalities and steering modes being semantically incorrect, where the first response includes a first cause value indicative of the ATSSS steering functionalities and steering modes as being semantically incorrect. The NE may further be configured to, capable of, or operable to transmit a second response that indicates a rejection for the establishment of the MA PDN connectivity service based at least in part on the ATSSS steering functionalities and steering modes being semantically incorrect, where the second response includes a second cause value mapped to the first cause value indicative of the ATSSS steering functionalities and steering modes as being semantically incorrect.

A processor (e.g., a standalone processor chipset, or a component of a NE) for wireless communication is described. The processor may be configured to, capable of, or operable to perform one or more operations as described herein. For example, the processor may be configured to, capable of, or operable to receive a first response that indicates a rejection for an establishment of a MA PDN connectivity service based at least in part on ATSSS steering functionalities and steering modes being semantically incorrect, where the first response includes a first cause value indicative of the ATSSS steering functionalities and steering modes as being semantically incorrect. The processor may be further configured to, capable of, or operable to transmit a second response that indicates a rejection for the establishment of the MA PDN connectivity service based at least in part on the ATSSS steering functionalities and steering modes being semantically incorrect, where the second response includes a second cause value mapped to the first cause value indicative of the ATSSS steering functionalities and steering modes as being semantically incorrect.

A method performed or performable by an NE (e.g., a core network entity, such as a MME, an ePDG, or other core network entity) for wireless communication is described. The method may include receiving a first response that indicates a rejection for an establishment of a MA PDN connectivity service based at least in part on ATSSS steering functionalities and steering modes being semantically incorrect, where the first response includes a first cause value indicative of the ATSSS steering functionalities and steering modes as being semantically incorrect. The method may further include transmitting a second response that indicates a rejection for the establishment of the MA PDN connectivity service based at least in part on the ATSSS steering functionalities and steering modes being semantically incorrect, where the second response includes a second cause value mapped to the first cause value indicative of the ATSSS steering functionalities and steering modes as being semantically incorrect.

### BRIEF DESCRIPTION OF THE DRAWINGS

FIG. 1 illustrates an example of a wireless communications system in accordance with aspects of the present disclosure.

FIG. 2 illustrates an example system, in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of an NE in accordance with aspects of the present disclosure.

FIG. 6 illustrates a flowchart of a method performed by an NE in accordance with aspects of the present disclosure.

FIG. 7 illustrates a flowchart of a method performed by an NE in accordance with aspects of the present disclosure.

FIG. 8 illustrates a flowchart of a method performed by a UE in accordance with aspects of the present disclosure.

### DETAILED DESCRIPTION

A wireless communication system, including one or more of UEs and NEs may be configured to be configured to, capable of, or operable to perform one or more operations in accordance with one or more technical specifications (TS) defined in 3rd Generation Partnership Project (3GPP). Additionally, the wireless communication system, including one or more of UEs and NE may be configured to be configured to, capable of, or operable to perform one or more operations in accordance with various Releases of respective TS defined in 3GPP. In Release 18 of 3GPP, encoding of supported ATSSS steering functionalities (ST) and steering modes was modified. As a result, depending on the 3GPP Release implemented by a respective NE, such as a user plane function (UPF), the UPF may interpret (e.g., determine) a request from a UE for steering functionality differently during establishment of a MA protocol data unit (PDU) session. At the 3GPP Core Network and Terminals Working Group 1, 153rd Meeting (CT1#153), it was agreed that, beginning with Release 18, a new set of steering functionalities and steering modes would be defined for MA PDU sessions, in addition to the ATSSS-ST rules previously specific in Release 16 and Release 17 of 3GPP TS 24.193.

3GPP TS 23.501 specifies multipath transmission control protocol (MPTCP), multipath QUIC (MPQUIC), and ATSSS lower layer (ATSSS-LL) steering functionalities. The MPQUIC steering functionality may be applied to internet protocol (IP), user datagram protocol (UDP), and Ethernet, denoted as MPQUIC-IP, MPQUIC-UDP, and MPQUIC-E, respectively. According to 3GPP TS 23.501, a UPF shall, at a minimum, support ATSSS-LL functionality with Active Standby steering mode. At the time of MA PDU session establishment, a UE may select one of the steering functionality: ATSSS-LL functionality with any steering mode; MPTCP functionality with any steering mode and ATSSS-LL functionality with only Active-Standby steering mode; multipath QUIC over User Datagram Protocol (MPQUIC-UDP) functionality with any steering mode and ATSSS-LL functionality with only Active-Standby steering mode; MPQUIC over IP (MPQUIC IP) functionality with any steering mode without ATSSS-LL functionality; MPQUIC IP functionality with any steering mode and ATSSS-LL functionality with only Active-Standby steering mode; and/or MPQUIC-E functionality with any steering mode and ATSSS-LL functionality with only Active-Standby steering mode.

As of the 3GPP Core Network and Terminals Working Group 1, 153rd Meeting (CT1#153), the configuration defined for Release 19 is to be compared to the configuration specified in Release 17. In Release 17, the supported configurations include: ATSSS-LL functionality with any steering mode; MPTCP functionality with any steering mode and ATSSS-LL functionality with any steering mode; MPTCP functionality with any steering mode and ATSSS-LL functionality with only Active-Standby steering mode. The change to the ATSSS requirement in Release 19, together with the newly adopted structure beginning in Release 18 of 3GPP TS 24.501, introduced a mismatch between the behaviors of UEs and NEs (e.g., legacy and non-legacy network entities). To address this mismatch, at the 3GPP Core Network and Terminals Working Group 1, 154th Meeting (CT1#154), a set of solutions was agreed upon, as presented in C1-252532 for Release 16, C1-252105 for Release 17, C1-252565 for Release 18, and C1-252564 for Release 19. These solutions resolve the mismatch by defining a new abnormal behavior for the NE when a MA PDU session establishment request is received with misinterpreted steering functionality and steering mode resulting from the mismatch.

While the solution described in C1-252532 for Release 16, C1-252105 for Release 17, C1-252565 for Release 18, and C1-252564 for Release 19 are applicable, for example, to a 5G system (5GS), these solutions cannot be directly applied to resolve the same issue in an evolved packet system (EPS), whether using 3GPP access or untrusted non-3GPP access. Accordingly, the present disclosure provides a solution for resolving the same type of mismatch when the UE is connected to EPS.

Aspects of the present disclosure are described in the context of a wireless communications system. In some implementations, an MA PDU session may be established when a UE first establishes a PDN connection as a primary leg, where additional legs over other access networks may subsequently be added to the MA PDU session. In such implementation, evolved universal terrestrial radio access network (E-UTRAN) may be connected to an evolved packet core (EPC), or an untrusted non-3GPP access network may be connected to the EPC, to serve as a user-plane resource of the MA PDU session to be established.

Aspects of the disclosure include addressing when the MA PDU session is established as the first leg a PDN connection over E-UTRAN connected to EPC or untrusted non-3GPP access network connected to EPC. Additional aspects of this disclosure include using the current existing cause values that the network generates if such abnormal cases occur.

Table 6.1.6.2-1 in 3GPP TS 24.193 which defines ATSSS request PCO parameter container contents, is now according to:

Supported ATSSS steering functionalities and steering modes (ATSSS-ST) (octet 1, bits 1, 2,
3 and 4) (NOTE 1)
This field indicates the 5GSM capability of ATSSS steering functionalities and steering
modes.
Bits

| | | | | |
|---|---|---|---|---|
| 4 | 3 | 2 | 1 | |
| 0 | 0 | 0 | 0 | ATSSS-LL functionality not supported (NOTE 3) |
| 0 | 0 | 0 | 1 | ATSSS Low-Layer functionality with any steering mode allowed |
| | | | | for ATSSS-LL supported |
| 0 | 0 | 1 | 0 | MPTCP functionality with any steering mode and ATSSS-LL |
| | | | | functionality with only active-standby steering mode supported |
| 0 | 0 | 1 | 1 | MPTCP functionality with any steering mode and ATSSS-LL |
| | | | | functionality with any steering mode allowed for ATSSS-LL |
| | | | | supported |

All other values are reserved.
ATSSS-LL functionality support (ATSSS-LL) (octet 1, bits 5 to 6) (NOTE 1)
This field indicates the support for ATSSS-LL functionality.
Bits

| | | |
|---|---|---|
| 6 | 5 | |
| 0 | 0 | ATSSS-LL functionality not supported |
| 0 | 1 | ATSSS-LL functionality with only active-standby steering mode |
| | | supported |
| 1 | 0 | ATSSS-LL functionality with any steering mode allowed for ATSSS-LL |
| | | supported |
| 1 | 1 | Spare |

Supporting MPTCP functionality with any steering mode (MPTCP) (octet 1, bit 7) (NOTE 1)
This bit indicates whether the MPTCP functionality with any steering mode is supported.
(NOTE 2)
Bit

| | |
|---|---|
| 7 | |
| 0 | MPTCP functionality with any steering mode not supported |
| 1 | MPTCP functionality with any steering mode supported |

Supporting MPQUIC-UDP functionality with any steering mode (MPQUIC-UDP) (octet 1,
bit 8) (NOTE 1)
This bit indicates whether the MPQUIC-UDP functionality with any steering mode is
supported. (NOTE 2)
Bit

| | |
|---|---|
| 8 | |
| 0 | MPQUIC-UDP functionality with any steering mode not supported |
| 1 | MPQUIC-UDP functionality with any steering mode supported |

Supporting MPQUIC-IP functionality with any steering mode (MPQUIC-IP) (octet 2, bit 1)
(NOTE 1)
This bit indicates whether the MPQUIC-IP functionality with any steering mode is supported.
Bit

| | |
|---|---|
| 1 | |
| 0 | MPQUIC-IP functionality with any steering mode not supported |
| 1 | MPQUIC-IP functionality with any steering mode supported |

Supporting MPQUIC-E functionality with any steering mode (MPQUIC-E) (octet 2, bit 2)
(NOTE 1)
This bit indicates whether the MPQUIC-UDP functionality with any steering mode is
supported. (NOTE 2)
Bit

| | |
|---|---|
| 2 | |
| 0 | MPQUIC-E functionality with any steering mode not supported |
| 1 | MPQUIC-E functionality with any steering mode supported |

ATSSS rules provisioning support indicator (ARPSI) (octet 2, bit 3)
Bit

| | |
|---|---|
| 8 | |
| 0 | ATSSS rules provisioning via 3GPP access connected to EPS not supported |
| 1 | ATSSS rules provisioning via 3GPP access connected to EPS supported |

NOTE 1:
If the ATSSS request PCO parameter is included in the PDN CONNECTIVITY REQUEST message with the request type information element set to “handover”, the ATSSS-ST field, ATSSS-LL field, MPTCP bit, MPQUIC-UDP bit, MPQUIC-IP bit and MPQUIC-E bit are ignored.
NOTE 2:
If ATSSS-LL is set to 00 then this bit shall be set to 0.
NOTE 3:
This value will trigger error handling in the network compliant with the previous releases of the specification.

where, the bits 1, 2, 3, and 4 represent the support by the UE and the network in release 16 onwards; the bits 5, 6, 7, and 8 represent the support by the UE and the network in release 18 onwards; and the bits 1 and 2 represent the support by the UE and the network in release 19 onwards.

According to 3GPP TS 23.501, release 18 UE may choose MPQUIC-UDP functionality with any steering mode and ATSSS-LL functionality with only Active-Standby steering mode. According to 3GPP TS 23.501, release 19 UE may, at the time of MA PDU session establishment, choose MPQUIC-UDP functionality with any steering mode and ATSSS-LL functionality with only Active-Standby steering mode; MPQUIC IP functionality with any steering mode without any ATSSS-LL functionality; MPQUIC IP functionality with any steering mode and ATSSS-LL functionality with only Active-Standby steering mode; or MPQUIC-E functionality with any steering mode and ATSSS-LL functionality with only Active-Standby steering mode. Any of the above steering functionalities may not be encoded in the way that the release 16 and release 17 UPF understand. In addition, release 19 UE may choose MPQUIC IP functionality with any steering mode without any ATSSS-LL functionality, at the time of MA PDU session establishment. However, even release 18 UPF may not understand the encoding and interprets the UE not being capable of any ATSSS elated steering functionality.

Table 1 shows the lack of compatibility between releases of the UE and the UPF.

TABLE 1
Non-compatible steering functionalities when UE and UPF are from different releases

| | UPF (Release- | UPF (Release- | UPF (Release- | UPF (Release- |
|---|---|---|---|---|
| | 16) | 17) | 18) | 19) |
| UE (Release-16) | None | None | None | None |
| UE (Release-17) | None | None | None | None |
| UE (Release-18) | MPQUIC-UDP | MPQUIC-UDP | None | None |
| | and ATSSS-LL | and ATSSS-LL | | |
| | with only Active- | with only Active- | | |
| | Standby steering | Standby steering | | |
| | mode | mode | | |
| UE (Release-19) | MPQUIC-UDP | MPQUIC-UDP | MPQUIC-IP | None |
| | and ATSSS-LL | and ATSSS-LL | without ATSSS- | |
| | with only Active- | with only Active- | LL | |
| | Standby steering | Standby steering | | |
| | mode | mode | | |
| | MPQUIC-IP | MPQUIC-IP | | |
| | without ATSSS- | without ATSSS- | | |
| | LL | LL | | |
| | MPQUIC-IP and | MPQUIC-IP and | | |
| | ATSSS-LL with | ATSSS-LL with | | |
| | only Active- | only Active- | | |
| | Standby steering | Standby steering | | |
| | mode | mode | | |
| | MPQUIC-E and | MPQUIC-E and | | |
| | ATSSS-LL with | ATSSS-LL with | | |
| | only Active- | only Active- | | |
| | Standby steering | Standby steering | | |
| | mode | mode | | |

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

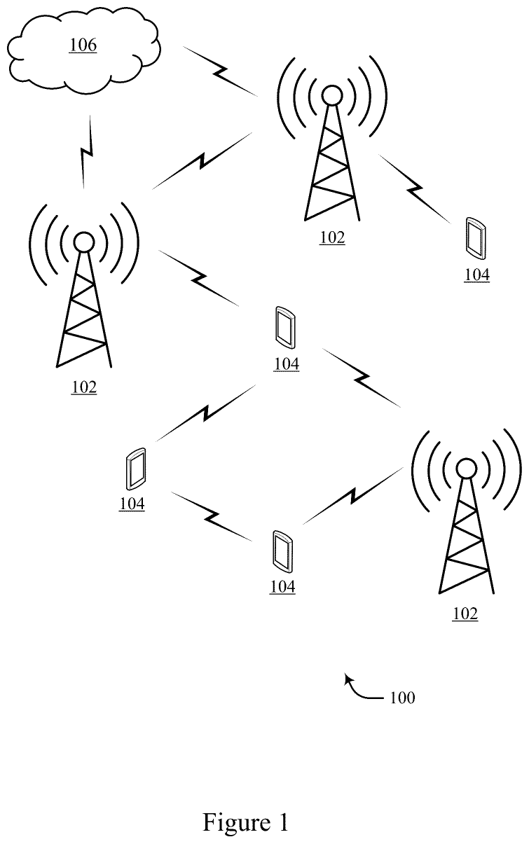

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a MME, an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 transmits a first request for establishment of a MA PDN connectivity service, where the first request includes a PCO IE or an ePCO IE, each including ATSSS steering functionalities and steering modes, where the ePCO IE includes one or more ATSSS request PCO parameter container contents; and receives a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect. In an example, semantic correctness may refer to whether the content/values of those IEs make sense in the protocol context given the state of things (e.g. state machine, capability, current configuration, allowed values, interdependencies). When a message or IE is semantically incorrect, it may mean while the message may be syntactically okay (the required IEs are present, formats valid), one or more of the contents (values) violate protocol rules (constraints, allowed ranges, consistency checks); or the message may conflict with the current state or capabilities, or violates dependencies among parameters (e.g. referring to a functionality the other side doesn't support.) Semantically correct may mean that parameters are consistent with the protocol rules, permissible values, dependencies, and state. In another example, “Semantically incorrect” may mean that the meaning or interpretation of terms, procedures, or specifications is unclear, misleading, or inconsistent, even if the syntax or grammar is technically correct. A specification or statement may be semantically incorrect if it uses terms inconsistently across different sections or documents, leading to confusion about their intended behavior or scope; fails to clearly define the roles or actions of network entities (e.g., UE, SMF, UPF) in steering procedures; imprecisely describes conditions or outcomes, resulting in multiple possible interpretations by implementers; or overlaps or conflates concepts (e.g., steering vs. switching vs. splitting) without clear boundaries. An NE 102 (e.g., a base station, gNB) communicates a first request for establishment of a MA PDN connectivity service, where the first request includes a PCO IE or an ePCO IE, each including ATSSS steering functionalities and steering modes; and transmits a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect. In another implementation, an NE 102 (e.g., a base station, gNB) receives a first response that indicates a rejection for an establishment of a MA PDN connectivity service based at least in part on ATSSS steering functionalities and steering modes being semantically incorrect, where the first response includes a first cause value indicative of the ATSSS steering functionalities and steering modes as being semantically incorrect; and transmits a second response that indicates a rejection for the establishment of the MA PDN connectivity service based at least in part on the ATSSS steering functionalities and steering modes being semantically incorrect, where the second response includes a second cause value mapped to the first cause value indicative of the ATSSS steering functionalities and steering modes as being semantically incorrect.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

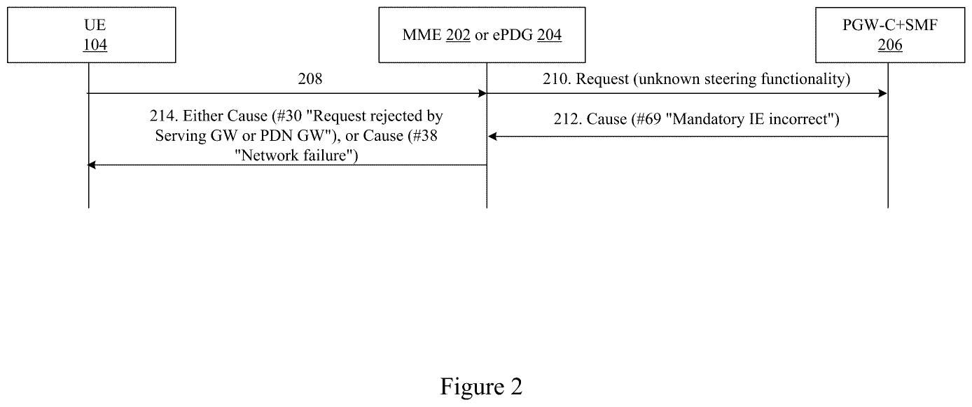

FIG. 2 illustrates an example system 200 in accordance with aspects of the present disclosure. With reference to E-UTRAN, 3GPP TS 24.193 [1] and 3GPP TS 23.316 [4] identify that the Multiple Access PDU connectivity service may be established in the EPS going back to release 16. Therefore, any solution should be applicable back to release 16. Although 3GPP TS 24.302 [5] contains the EPS session management (ESM) cause #95 “Semantically incorrect message”, table C.1 in 3GPP TS 29.274 [6] does not map any S11/S4 to non-access stratum (NAS) ESM cause #95. In fact, clause 7.7.8 in 3GPP TS 29.274 [6] states that if an information element is semantically incorrect, the cause shall be set to #69 “Mandatory IE incorrect”. Furthermore, according to table C.1 in 3GPP TS 29.274 [6] cause #69 “Mandatory IE incorrect” is either mapped to ESM cause #30 “Request rejected by Serving GW or PDN GW” or ESM cause #38 “Network failure”.

At 208, the UE 104 may transmit a first request for establishment of an MA PDN connectivity service to the MME 202 via a 3GPP access, or to the ePDG 204 via a non 3GPP access. The first request may include a PCO IE or an ePCO IE including an ATSSS request PCO parameter container contents including ATSSS steering functionalities and steering modes.

At 210, the MME 202 via a 3GPP access, or the ePDG 204 via a non 3GPP access may transmit to the PGW-C+SMF 206 a second request for establishment of the MA PDN connectivity service including the PCO IE or the ePCO IE.

At 212, the PGW-C+SMF 206 may transmit to the MME 202 via a 3GPP access, or to the ePDG 204 via a non 3GPP access, a second response as a rejection for the establishment of the MA PDN connectivity service due to the ATSSS steering functionalities and steering modes being semantically incorrect. The second response may include a first cause value to identify the ATSSS steering functionalities and steering modes being semantically incorrect. In one example, the first cause value may be #69 “Mandatory IE incorrect.”

At 214, the MME 202 via a 3GPP access, or the ePDG 204 via a non 3GPP access may transmit to the UE 104, a first response as rejection for the establishment of the MA PDN connectivity service due to the ATSSS steering functionalities and steering modes being semantically incorrect, The first response may include a second cause value mapped to the first cause value to identify the ATSSS steering functionalities and steering modes being semantically incorrect.

In aspects of this disclosure, if the MA PDU connectivity service fails when the UE attempts to establish PDN connection over E-UTRAN connected to EPC as a user-plane resource of an MA PDU session to be established as described in clause 5.3.1 of 3GPP TS 24.193 [1], if the PGW-C+SMF receives Create Session Request message containing the ePCO IE with: the ATSSS request PCO parameter that indicates “ATSSS not supported”; the ATSSS request PCO parameter that does not indicate any steering functionality or steering mode; or the ATSSS request PCO parameter that indicates some error, the PGW-C+SMF shall handle the ePCO IE according to clause 7.7.8 in 3GPP TS 29.274 [18] and reject by constructing the Create Session Response message with the reject cause value #69 “Mandatory IE incorrect” in the ATSSS response with the length of two octets PCO parameter container contents in the ePCO IE.

When the MME receives the Create Session Response message with the reject cause value #69 “Mandatory IE incorrect” and the ePCO IE from the serving gateway (SGW) as specified in 3GPP TS 29.274 [18], the MME shall construct the PDN CONNECTIVITY REJECT message with the ESM cause containing the cause value #30 “Request rejected by Serving GW or PDN GW” and include the received ePCO IE and forward the message towards the UE as specified in 3GPP TS 24.301 [4]. The MME uses the mapping of the rejection cause values listed in annex C of 3GPP TS 29.274 [18].

Aspects of the present disclosure include solutions to untrusted non-3GPP occasions. 3GPP TS 24.193 [1] and 3GPP TS 24.302 [5] identify that the MA PDU connectivity service with a connection via the untrusted non-3GPP access goes back to release 18. Therefore, the solution for the untrusted non-3GPP should be applicable for release 18 onwards. Table 8.1.4.10-1 in 3GPP TS 24.302 [5] lists the cause values, thus, cause #69 “Mandatory IE incorrect” in table C0.1 in 3GPP TS 29.274 [6] can either be mapped to cause #30 “Request rejected by PDN GW” or cause #38 “Network failure” in table 8.1.4.10-1 in 3GPP TS 24.302 [5].

Therefore, if the MA PDU connectivity service fails when the UE attempts to establish PDN connection over untrusted non-3GPP connected to EPC as a user-plane resource of an MA PDU session to be established as described in clause 5.3.1 of 3GPP TS 24.193 [1], if the PGW-C+SMF receives Create Session Request message containing the ePCO IE with: the ATSSS request PCO parameter that indicates “ATSSS not supported”; the ATSSS request PCO parameter that does not indicate any steering functionality or steering mode; or the ATSSS request PCO parameter that indicates some error, the PGW-C+SMF shall handle the ePCO IE according to clause 7.7.8 in 3GPP TS 29.274 [18] and reject by constructing the Create Session Response message with the reject cause value #69 “Mandatory IE incorrect” in the ATSSS response with the length of two octets PCO parameter container contents in the ePCO IE.

When the ePDG receives the Create Session Response message with a reject cause value #69 “Mandatory IE incorrect” and the ePCO IE from the PGW-C+SMF as specified in 3GPP TS 29.274 [18], the ePDG shall construct the ATSSS_RESPONSE Notify payload as specified in 3GPP TS 24.302 [17], copy the ATSSS response with the length of two octets PCO parameter container contents into the ATSSS response information field of the ATSSS_RESPONSE Notify payload, and include the ATSSS_RESPONSE Notify payload in the IKE_AUTH response message. The ePDG shall also include a Notify payload with a private notify message to the UE, indicating an error in the IKE_AUTH response message.

It may be up to the implementation of the ePDG, which private notify message error type value is included in the IKE_AUTH response message based on the reject cause value #69 “Mandatory IE incorrect” received in the Create Session Response message as specified in 3GPP TS 29.274 [18]. Or ePDG may map the reject cause value #69 “Mandatory IE incorrect” to the cause #30 “Request rejected by PDN GW” or #38 “Network Failure” as specified in 3GPP TS 24.302 [17].

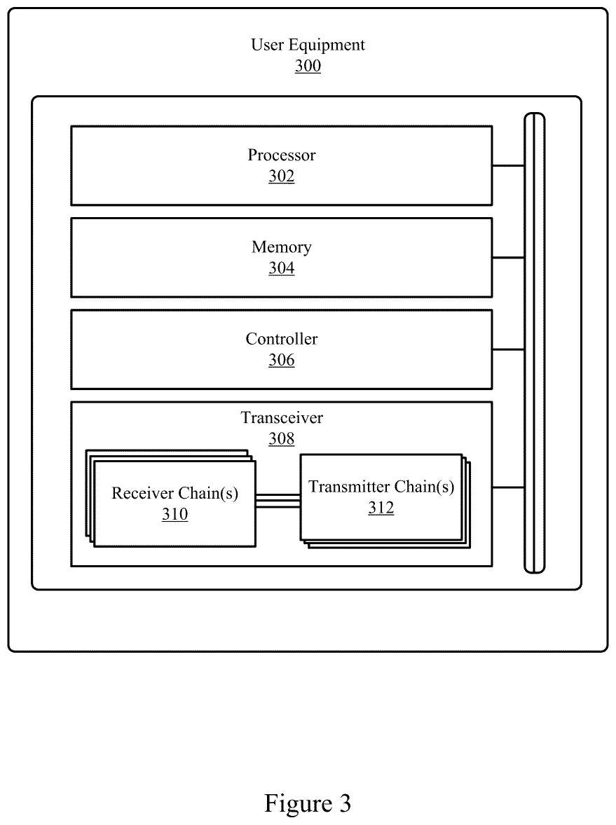

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 cause the UE 300 to perform various functions described herein. The code may be stored in a non-transitory computer-readable medium such as the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to or operable to support a means for transmitting a first request for establishment of a MA PDN connectivity service, where the first request includes a PCO IE or an ePCO IE, each including ATSSS steering functionalities and steering modes, where the ePCO IE includes one or more ATSSS request PCO parameter container contents; and receiving a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect.

Additionally, or alternatively, the UE 300 may support at least one memory (e.g., the memory 304) and at least one processor (e.g., the processor 302) coupled with the at least one memory and configured to cause the UE to transmit a first request for establishment of a MA PDN connectivity service, where the first request includes a PCO IE or an ePCO IE, each including ATSSS steering functionalities and steering modes, where the ePCO IE includes one or more ATSSS request PCO parameter container contents; and receive a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive a signal over the air or wireless medium. The receiver chain 310 may include at least one amplifier (e.g., a low-noise amplifier (LNA)) configured to amplify the received signal. The receiver chain 310 may include at least one demodulator configured to demodulate the receive signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

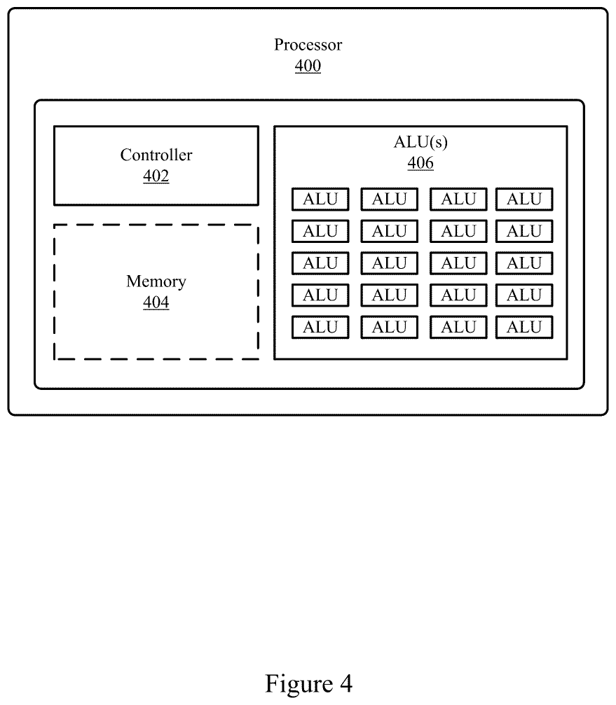

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, ALUs 406, and other functional units of the processor 400.

The memory 404 may include one or more caches (e.g., memory local to or included in the processor 400 or other memory, such as RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, and the controller 402, and may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 may be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to transmit a first request for establishment of a MA PDN connectivity service, where the first request includes a PCO IE or an ePCO IE, each including ATSSS steering functionalities and steering modes, where the ePCO IE includes one or more ATSSS request PCO parameter container contents; and receive a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect. In another implementation, the processor 400 may be configured to or operable to support at least one controller (e.g., the controller 402) coupled with at least one memory (e.g., the memory 404) and configured to cause the processor to receive a first request for establishment of a MA PDN connectivity service, where the first request includes a PCO IE or an ePCO IE, each including ATSSS steering functionalities and steering modes; and transmit a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect. In an implementation, the processor 400 may be configured to or operable to support at least one controller (e.g., the controller 402) coupled with at least one memory (e.g., the memory 404) and configured to cause the processor to receive a first response that indicates a rejection for an establishment of a MA PDN connectivity service based at least in part on ATSSS steering functionalities and steering modes being semantically incorrect, where the first response includes a first cause value indicative of the ATSSS steering functionalities and steering modes as being semantically incorrect; and transmit a second response that indicates a rejection for the establishment of the MA PDN connectivity service based at least in part on the ATSSS steering functionalities and steering modes being semantically incorrect, where the second response includes a second cause value mapped to the first cause value indicative of the ATSSS steering functionalities and steering modes as being semantically incorrect.

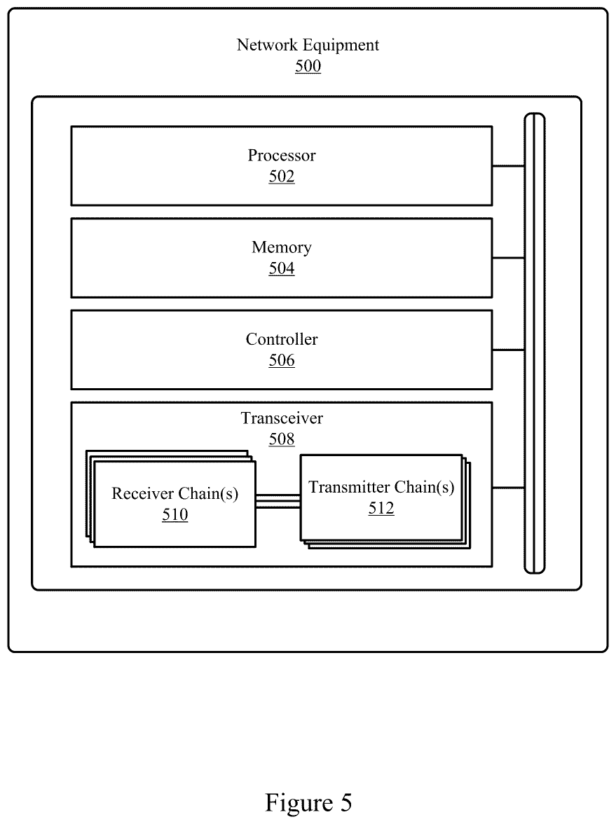

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein. The NE 500 may be configured to or operable to support a means for receiving a first request for establishment of a MA PDN connectivity service, where the first request includes a PCO IE or an ePCO IE, each including ATSSS steering functionalities and steering modes; and transmitting a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect, where the first response includes a first cause value to identify the ATSSS steering functionalities and steering modes as being semantically incorrect. In another implementation, the NE 500 may be configured to or operable to support a means for receiving a first response as a rejection for an establishment of a MA PDN connectivity service based at least in part on ATSSS steering functionalities and steering modes being semantically incorrect, where the first response includes a first cause value to identify the ATSSS steering functionalities and steering modes as being semantically incorrect; and transmitting a second response as a rejection for the establishment of the MA PDN connectivity service based at least in part on the ATSSS steering functionalities and steering modes being semantically incorrect, where the second response includes a second cause value mapped to the first cause value to identify the ATSSS steering functionalities and steering modes as being semantically incorrect.

Additionally, the NE 500 may be configured to or operable to support any one or combination of where the ePCO IE may include ATSSS request PCO parameter container contents, the first cause value may include #69 “Mandatory IE incorrect.” The NE may be a PGW-C+SMF, receiving a first request for the establishment of the MA PDN connectivity service including a PCO IE or an ePCO IE including ATSSS steering functionalities and steering modes, transmitting a second request for the establishment of the MA PDN connectivity service including the PCO IE or the ePCO IE, the second response may include the ePCO IE, mapping the first cause value to #30 “Request rejected by Serving GW or PDN GW” when the MA PDN connectivity service is connected via an EPS. Mapping the first cause value to the second cause value based at least in part on implementation, or mapping the first cause value to #30 “Request rejected by PDN GW” or #38 “Network Failure” when the MA PDN connectivity service is connected via an untrusted non-3GPP, the NE may be a MME or an evolved ePDG, the first cause value may include #69 “Mandatory IE incorrect”, mapping the first cause value to #38 “Network Failure,” and/or transmitting a private notify message including an error in the second response.

Additionally, or alternatively, the NE 500 may support at least one memory (e.g., the memory 504) and at least one processor (e.g., the processor 502) coupled with the at least one memory and configured to cause the NE to receive a first request for establishment of a MA PDN connectivity service, where the first request includes a PCO IE or an ePCO IE, each including ATSSS steering functionalities and steering modes; and transmit a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect. In another implementation, the NE 500 may support at least one memory (e.g., the memory 504) and at least one processor (e.g., the processor 502) coupled with the at least one memory and configured to cause the NE to receive a first response as a rejection for an establishment of a MA PDN connectivity service based at least in part on ATSSS steering functionalities and steering modes being semantically incorrect, where the first response includes a first cause value to identify the ATSSS steering functionalities and steering modes as being semantically incorrect; and transmit a second response as a rejection for the establishment of the MA PDN connectivity service based at least in part on the ATSSS steering functionalities and steering modes being semantically incorrect, where the second response includes a second cause value mapped to the first cause value to identify the ATSSS steering functionalities and steering modes as being semantically incorrect.

Additionally, the NE 500 may be configured to support any one or combination of where the ePCO IE may include ATSSS request PCO parameter container contents, the first cause value may include #69 “Mandatory IE incorrect,” the NE may be a PGW-C+SMF, the NE may receive a first request for the establishment of the MA PDN connectivity service including a PCO IE or an ePCO IE including ATSSS steering functionalities and steering modes, the NE may transmit a second request for the establishment of the MA PDN connectivity service including the PCO IE or the ePCO IE, the second response may include the ePCO IE. The NE may map the first cause value to #30 “Request rejected by Serving GW or PDN GW,” when the MA PDN connectivity service is connected via an EPS. The NE may map the first cause value to the second cause value based at least in part on implementation, or map the first cause value to #30 “Request rejected by PDN GW” or #38 “Network Failure,” when the MA PDN connectivity service is connected via an untrusted non-3GPP. The NE may be a MME or an evolved ePDG. The first cause value may include #69 “Mandatory IE incorrect.” The NE may map the first cause value to #38 “Network Failure.” The NE may transmit a private notify message including an error in the second response.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

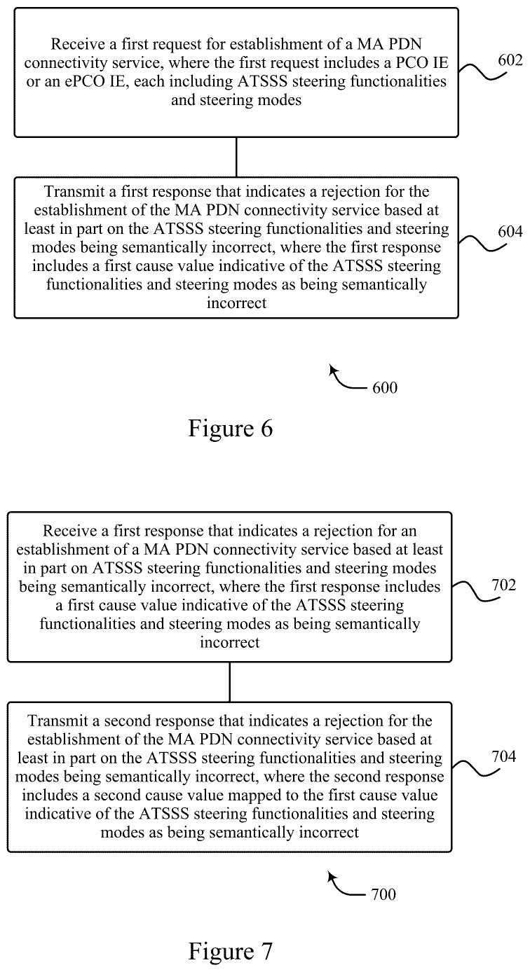

FIG. 6 illustrates a flowchart of a method 600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 602, the method may include receiving a first request for establishment of a MA PDN connectivity service, where the first request includes a PCO IE or an ePCO IE, each including ATSSS steering functionalities and steering modes. The operations of 602 may be performed in accordance with examples as described herein. In some implementations, aspects of the operations of 602 may be performed by an NE as described with reference to FIG. 5.

At 604, the method may include transmitting a first response that indicates a rejection for the establishment of the MA PDN connectivity service based at least in part on the ATSSS steering functionalities and steering modes being semantically incorrect, where the first response includes a first cause value indicative of the ATSSS steering functionalities and steering modes as being semantically incorrect. The operations of 604 may be performed in accordance with examples as described herein. In some implementations, aspects of the operations of 704 may be performed by an NE as described with reference to FIG. 5.

FIG. 7 illustrates a flowchart of a method 700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include receiving a first response that indicates a rejection for an establishment of a MA PDN connectivity service based at least in part on ATSSS steering functionalities and steering modes being semantically incorrect, where the first response includes a first cause value indicative of the ATSSS steering functionalities and steering modes as being semantically incorrect. The operations of 702 may be performed in accordance with examples as described herein. In some implementations, aspects of the operations of 702 may be performed by an NE as described with reference to FIG. 5.

At 704, the method may include transmitting a second response that indicates a rejection for the establishment of the MA PDN connectivity service based at least in part on the ATSSS steering functionalities and steering modes being semantically incorrect, where the second response includes a second cause value mapped to the first cause value indicative of the ATSSS steering functionalities and steering modes as being semantically incorrect. The operations of 704 may be performed in accordance with examples as described herein. In some implementations, aspects of the operations of 704 may be performed by an NE as described with reference to FIG. 5.

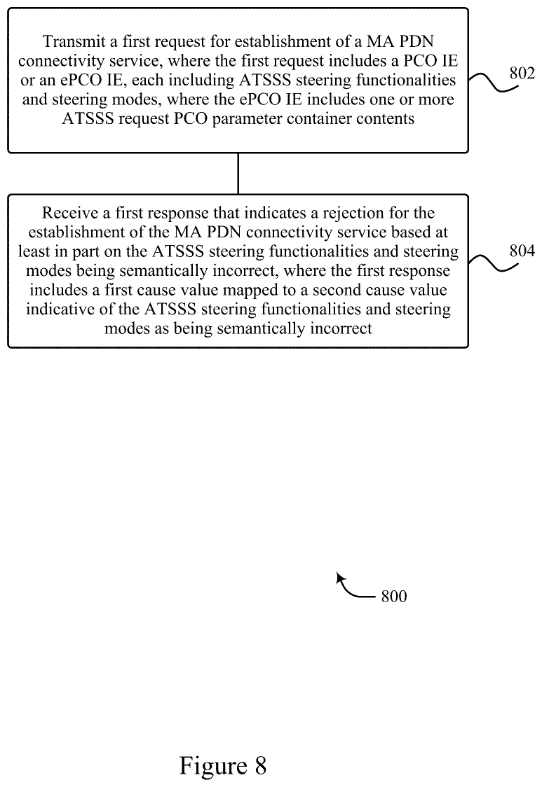

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include transmitting a first request for establishment of a MA PDN connectivity service, where the first request includes a PCO IE or an ePCO IE, each including ATSSS steering functionalities and steering modes, where the ePCO IE includes one or more ATSSS request PCO parameter container contents. The operations of 802 may be performed in accordance with examples as described herein. In some implementations, aspects of the operations of 802 may be performed by a UE as described with reference to FIG. 3.

At 804, the method may include receiving a first response that indicates a rejection for the establishment of the MA PDN connectivity service based at least in part on the ATSSS steering functionalities and steering modes being semantically incorrect, where the first response includes a first cause value mapped to a second cause value indicative of the ATSSS steering functionalities and steering modes as being semantically incorrect. The operations of 804 may be performed in accordance with examples as described herein. In some implementations, aspects of the operations of 804 may be performed by a UE as described with reference to FIG. 3.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network equipment (NE) for wireless communication, comprising:
at least one memory; and
at least one processor coupled with the at least one memory and operable to cause the NE to:
receive a first request for establishment of a muti-access (MA) packet data network (PDN) connectivity service, wherein the first request comprises a protocol configuration options (PCO) information element (IE) or an extended PCO (ePCO) IE, each comprising access traffic steering, switching, and splitting (ATSSS) steering functionalities and steering modes; and
transmit a first response that indicates a rejection for the establishment of the MA PDN connectivity service based at least in part on the ATSSS steering functionalities and steering modes being semantically incorrect, wherein the first response comprises a first cause value indicative of the ATSSS steering functionalities and steering modes as being semantically incorrect.

2. The NE of claim 1, wherein the ePCO IE comprises one or more ATSSS request PCO parameter container contents.

3. The NE of claim 1, wherein the first cause value comprises #69 “Mandatory IE incorrect.”

4. The NE of claim 1, wherein the NE is a packet gateway control plane and a session management function (PGW-C+SMF).

5. A network equipment (NE) for wireless communication, comprising:
at least one memory; and
at least one processor coupled with the at least one memory and operable to cause the NE to:
receive a first response that indicates a rejection for an establishment of a muti-access (MA) packet data network (PDN) connectivity service based at least in part on access traffic steering, switching, and splitting (ATSSS) steering functionalities and steering modes being semantically incorrect, wherein the first response comprises a first cause value indicative of the ATSSS steering functionalities and steering modes as being semantically incorrect; and
transmit a second response that indicates a rejection for the establishment of the MA PDN connectivity service based at least in part on the ATSSS steering functionalities and steering modes being semantically incorrect, wherein the second response comprises a second cause value mapped to the first cause value indicative of the ATSSS steering functionalities and steering modes as being semantically incorrect.

6. The NE of claim 5, wherein the at least one processor is operable to cause the NE to:
receive a first request for the establishment of the MA PDN connectivity service comprising a protocol configuration options (PCO) information element (IE) or an extended PCO (ePCO) IE, each comprising ATSSS steering functionalities and steering modes.

7. The NE of claim 6, wherein the at least one processor is operable to cause the NE to:
transmit a second request for the establishment of the MA PDN connectivity service comprising the PCO IE or the ePCO IE.

8. The NE of claim 7, wherein the second response further comprises the ePCO IE.

9. The NE of claim 5, wherein when the MA PDN connectivity service is connected via an evolved packet system (EPS), the at least one processor is operable to cause the NE to map the first cause value to #30 “Request rejected by Serving GW or PDN GW.”

10. The NE of claim 5, wherein when the MA PDN connectivity service is connected via an untrusted non-3rd Generation Partnership Project (3GPP) access network, the at least one processor is operable to cause the NE to map the first cause value to the second cause value based at least in part on implementation, or map the first cause value to #30 “Request rejected by PDN GW” or #38 “Network Failure”.

11. The NE of claim 5, wherein the NE is a mobility management entity (MME) or an evolved packet data gateway (ePDG).

12. The NE of claim 5, wherein the first cause value comprises #69 “Mandatory IE incorrect.”

13. The NE of claim 12, wherein the at least one processor is operable to cause the NE to map the first cause value to #38 “Network Failure.”

14. The NE of claim 5, wherein the at least one processor is operable to cause the NE to transmit a private notify message including an error in the second response.

15. A method performed by a network equipment (NE), the method comprising:
receiving a first response that indicates a rejection for an establishment of a muti-access (MA) packet data network (PDN) connectivity service based at least in part on access traffic steering, switching, and splitting (ATSSS) steering functionalities and steering modes being semantically incorrect, wherein the first response comprises a first cause value indicative of the ATSSS steering functionalities and steering modes as being semantically incorrect; and
transmitting a second response that indicates a rejection for the establishment of the MA PDN connectivity service based at least in part on the ATSSS steering functionalities and steering modes being semantically incorrect, wherein the second response comprises a second cause value mapped to the first cause value indicative of the ATSSS steering functionalities and steering modes as being semantically incorrect.

16. The method of claim 15, further comprising:
receiving a first request for the establishment of the MA PDN connectivity service comprising a protocol configuration options (PCO) information element (IE) or an extended PCO (ePCO) IE, each comprising ATSSS steering functionalities and steering modes.

17. The method of claim 16, further comprising:
transmitting a second request for the establishment of the MA PDN connectivity service comprising the PCO IE or the ePCO IE.

18. The method of claim 17, wherein the second response further comprises the ePCO IE.

19. The method of claim 16, further comprising mapping the first cause value to #30 “Request rejected by Serving GW or PDN GW,” when the MA PDN connectivity service is connected via an evolved packet system (EPS).

20. A user equipment (UE) for wireless communication, comprising:
at least one memory; and
at least one processor coupled with the at least one memory and operable to cause the UE to:
transmit a first request for establishment of a muti-access (MA) packet data network (PDN) connectivity service, wherein the first request comprises a protocol configuration options (PCO) information element (IE) or an extended PCO (ePCO) IE, each comprising ATSSS steering functionalities and steering modes, wherein the ePCO IE comprises one or more access traffic steering, switching, and splitting (ATSSS) request PCO parameter container contents; and
receive a first response that indicates a rejection for the establishment of the MA PDN connectivity service based at least in part on the ATSSS steering functionalities and steering modes being semantically incorrect, wherein the first response comprises a first cause value mapped to a second cause value indicative of the ATSSS steering functionalities and steering modes as being semantically incorrect.
